(19) United States
(12) Patent Application Publication
(10) Pub. No.: US 2024/0275555 A1
(43) Pub. Date: Aug. 15, 2024

(54) TERMINAL APPARATUS AND BASE STATION APPARATUS

(71) Applicant: SHARP KABUSHIKI KAISHA, Sakai City, Osaka (JP)

(72) Inventors: OSAMU NAKAMURA, Sakai City, Osaka (JP); HIROMICHI TOMEBA, Sakai City, Osaka (JP)

(21) Appl. No.: 18/681,622

(22) PCT Filed: Jun. 24, 2022
(86) PCT No.: PCT/JP2022/025414

§ 371 Date: Feb. 6, 2024

(30) Foreign Application Priority Data
Aug. 23, 2021 (JP) 2021-135432

(51) Int. Cl. H04L 5/00; H04J 13/00; H04W 72/0453; H04W 72/20

(52) U.S. Cl. CPC H04L 5/0051; H04J 13/0062; H04W 72/0453; H04W 72/20

(57) ABSTRACT

An uplink reference signal generation unit that generates a reference signal, and a reception unit that receives control information at least including information related to the number of allocation subcarriers and bandwidth extension transmitted from the base station apparatus are included. The uplink reference signal generation unit generates, by generating a Zadoff-Chu sequence based on the number of subcarriers after extension calculated based on the information related to the number of the allocation subcarriers and the bandwidth extension and cyclically extending the generated Zadoff-Chu sequence, a reference signal sequence having a sequence length whose number is equal to the number of the subcarriers after extension.

This application claims priority to JP 2021-135432 filed on Aug. 23, 2021, the contents of which are incorporated herein by reference.

### TECHNICAL FIELD

The present invention relates to a terminal apparatus and a base station apparatus.

### BACKGROUND ART

In New Radio (NR) being a standard of the fifth generation mobile communication system specified in the Third Generation Partnership Project (3GPP), in NR, one slot includes 14 OFDM symbols, and at least one Demodulation Reference Signal (DMRS) is mapped within one slot. In the specification, in a case that a Zadoff-Chu (ZC) sequence is used for the DMRS, and a bandwidth of a data spectrum is M subcarriers, by generating a sequence length m of the ZC sequence using the largest prime number not exceeding M and cyclically extending the ZC sequence of the sequence length m, the DMRS sequence having the length M is generated. In other words, multiple sequences having the same amplitude and phase appear within the sequence length M.

In NR, Cyclic Prefix Orthogonal Frequency Division Multiplexing (CP-OFDM) is employed as an access scheme, and in an uplink in particular, Discrete Fourier Transform Spread OFDM (DFT-S-OFDM) is also employed rather than CP-OFDM. This is because DFT-S-OFDM has a lower Peak-to-Average Power Ratio (PAPR) and a lighter load on an amplifier, in comparison to CP-OFDM. In a Beyond5G (B5G) era, it is considered that an even larger number of devices than that in the 5G era are connected to the Internet, and thus terminals need to be generated at lower costs. In addition, in B5G, use of frequencies higher than those in 5G has been under study. The higher frequencies lead to larger distance attenuation, and thus high electric field strength needs to be secured by forming pencil beams with a large number of antennas (antenna ports or antenna elements). However, this requires an amplifier for each antenna, and thus the manufacturing cost may increase as a larger number of antennas increases. In other words, even in a case that high frequencies are used, it is desirable to reduce the PAPR, in order to reduce costs of the amplifiers. In view of this, in NPL 1, a method of reducing the PAPR at the sacrifice of frequency efficiency is proposed. In the proposed method, by extending a bandwidth (1+α) times and applying spectrum formation to the extended bandwidth, the PAPR can be reduced. As a method of extending the bandwidth, performing cyclic extension on a frequency spectrum to be transmitted in the frequency domain has been proposed.

In NR, one slot includes 14 OFDM symbols, and at least one Demodulation Reference Signal (DMRS) is mapped within one slot. In the specification, in a case that a Zadoff-Chu (ZC) sequence is used for the DMRS, and a bandwidth of a data spectrum is M subcarriers, by generating a sequence length m of the ZC sequence using the largest prime number not exceeding M and cyclically extending the ZC sequence of the sequence length m, the DMRS sequence having the length M is generated. In other words, multiple sequences having the same amplitude and phase appear within the sequence length M.

The technique of NPL 1 can be applied not only to a data signal but also to the DMRS, and an application method is described in NPL 2. NPL 2 describes a technique of extending a cyclically extended sequence length M to (1+α)M through cyclic extension as a known method. In the known method, the cyclically extended sequence length M is extended, and thus there is a portion in which the ZC sequence is discontinuous between the extended subcarriers. This increases the PAPR. In view of this, NPL 2 proposes extension of the ZC sequence of the sequence length m before being cyclically extended to (1+α)M through cyclic extension. In the proposed method, there are no longer discontinuous portions observed in the known method, and thus the PAPR can be reduced.

### CITATION LIST

### Non Patent Literature

NPL 1: Nokia, Nokia Shanghai Bell, 3GPP RAN Rel-18 Workshop, RWS-210076, June 2021.

NPL 2: I. P. Nasarre, et al., in IEEE Open Journal of the Communications Society, vol. 2, pp. 1188-1204, 2021.

### SUMMARY OF INVENTION

### Technical Problem

Although NPL 2 proposes a method of generating the DMRS in a case that bandwidth extension is performed, a short ZC sequence is used despite that the bandwidth is extended. In a case that a short sequence length is repeatedly used through cyclic extension, it is considered that the PAPR is increased in comparison to a case that a long sequence length is used.

The present invention is made in view of the circumstances as described above and has an object to enable generation of a DMRS having a low PAPR in a case that bandwidth extension is performed.

### Solution to Problem

To address the above-mentioned drawbacks, a base station apparatus, a terminal apparatus, and a communication method according to the present invention are configured as follows.

(1) An aspect of the present invention is a terminal apparatus for performing communication with a base station apparatus and includes an uplink reference signal generation unit that generates a reference signal; and a reception unit that receives control information at least including the number of allocation subcarriers, information related to bandwidth extension, and information related to a configuration type of the uplink reference signal, the control information being transmitted from the base station apparatus. The uplink reference signal generation unit generates, by generating a Zadoff-Chu sequence based on the number of subcarriers after extension calculated based at least on the number of the allocation subcarriers, the information related to the bandwidth extension, and the information related to the configuration type of the uplink reference signal and cyclically extending the generated Zadoff-Chu sequence, a reference signal sequence having a sequence length whose number is equal to the number of the subcarriers after extension.

(2) In an aspect of the present invention, a sequence length of the Zadoff-Chu sequence may be generated using a largest prime number not exceeding the number of the subcarriers after extension.

(3) In an aspect of the present invention, a sequence length of the Zadoff-Chu sequence may be shorter than a largest prime number not exceeding the number of the subcarriers after extension and longer than a largest prime number not exceeding the number of the allocation subcarriers.

(4) In an aspect of the present invention, information related to a sequence length of the Zadoff-Chu sequence may be notified from the base station apparatus using the control information.

(5) An aspect of the present invention is a base station apparatus for performing communication with a terminal apparatus. A control unit that generates control information at least including information related to the number of allocation subcarriers and bandwidth extension and the radio reception unit receive an uplink reference signal obtained by cyclically extending a Zadoff-Chu sequence generated based on the number of subcarriers after extension calculated based on the information related to the number of the allocation subcarriers and the bandwidth extension in such a manner that the uplink reference signal has a sequence length whose number is equal to the number of the subcarriers after extension. The uplink reference signal is transmitted by the terminal apparatus.

(6) In an aspect of the present invention, a sequence length of the Zadoff-Chu sequence may be generated using a largest prime number not exceeding the number of the subcarriers after extension.

(7) In an aspect of the present invention, a sequence length of the Zadoff-Chu sequence may be shorter than a largest prime number not exceeding the number of the subcarriers after extension and longer than a largest prime number not exceeding the number of the allocation subcarriers.

(8) In an aspect of the present invention, information related to a sequence length of the Zadoff-Chu sequence may be included in the control information.

(9) In an aspect of the present invention, the uplink reference signal may include a first reference signal and a second reference signal. A signal sequence length configured for the second reference signal may be longer than the first reference signal sequence length.

(10) In an aspect of the present invention, a first control signal field and a second control signal field may be further transmitted. A bandwidth of a frequency spectrum of the second control signal field may be larger than a bandwidth of a frequency spectrum of the first control signal field.

### Advantageous Effects of Invention

According to one or multiple aspects of the present invention, by reducing a PAPR of a time waveform of a DMRS, a communication device can be manufactured using an inexpensive amplifier.

### BRIEF DESCRIPTION OF DRAWINGS

FIG. 1 is a diagram illustrating a configuration example of a communication system 1 according to the present embodiment.

FIG. 2 is a diagram illustrating a configuration example of a base station apparatus according to the present embodiment.

FIG. 3 is a diagram illustrating a configuration example of a terminal apparatus according to the present embodiment.

FIG. 4 is a diagram illustrating a ZC sequence length in a case that the number M_{ZC} of allocation subcarriers is 36.

FIG. 5 is a diagram illustrating known examples of a DMRS sequence in a case that bandwidth extension is applied.

FIG. 6 is a diagram illustrating a DMRS sequence in a case that bandwidth extension is applied.

FIG. 7 is a diagram illustrating PAPR characteristics of a DMRS sequence in a case that bandwidth extension is applied.

FIG. 8 is a diagram illustrating a conceptual diagram of a DMRS sequence in a case that bandwidth extension and frequency domain filtering are applied.

FIG. 9 is an overview diagram illustrating an example of a transmission frame format.

FIG. 10 is an overview diagram illustrating an example of a transmission frame format for the purpose of reducing overhead.

### DESCRIPTION OF EMBODIMENTS

A communication system according to the present embodiment includes a base station apparatus (a cell, a small cell, a serving cell, a component carrier, an eNodeB, a Home eNodeB, and a gNodeB) and a terminal apparatus (a terminal, a mobile terminal, and User Equipment (UE)). In the communication system, in a case of a downlink, the base station apparatus serves as a transmission apparatus (a transmission point, a transmit antenna group, a transmit antenna port group, or a Tx/Rx Point (TRP)), and the terminal apparatus serves as a reception apparatus (a reception point, a reception terminal, a receive antenna group, or a receive antenna port group). In a case of an uplink, the base station apparatus serves as the reception apparatus, and the terminal apparatus serves as the transmission apparatus. The communication system is also applicable to Device-to-Device or sidelink (D2D) communication. In this case, the terminal apparatus serves as both the transmission apparatus and the reception apparatus.

The communication system is not limited to one that is limited to data communication between the terminal apparatus and the base station apparatus with human intervention. In other words, the communication system is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). The communication system uses a transmission scheme such as Discrete Fourier Transform Spread-Orthogonal Frequency Division Multiplexing (DFTS-OFDM or also referred to as SC-FDMA) applying Transform precoding, that is, applying DFT in a case that a higher layer parameter related to Transform precoder is configured in the uplink. Although the following describes a case of using an OFDM transmission scheme in the uplink and the downlink, the transmission scheme is not limited to this, and another transmission scheme may be applicable.

The base station apparatus and the terminal apparatus according to the present embodiment can communicate in a frequency band for which an approval of use (license) has been obtained from a country or region where a radio operator provides services, that is, a so-called licensed band, and/or in a frequency band for which no approval (license) from the country or region is required, that is, a so-called unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### First Embodiment

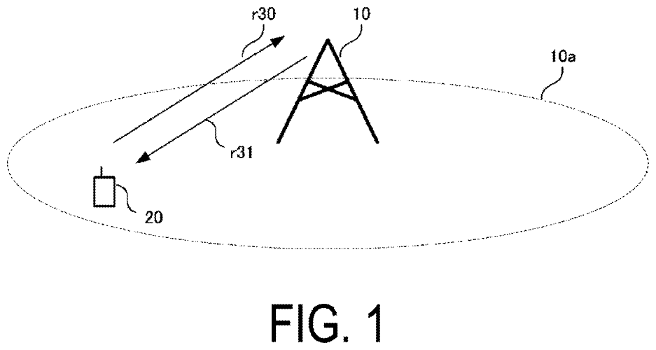

FIG. 1 is a diagram illustrating a configuration example of a communication system 1 according to the present embodiment. The communication system 1 according to the present embodiment includes a base station apparatus 10 and a terminal apparatus 20. Coverage 10a is a range (a communication area) in which the base station apparatus 10 can connect to (communicate with) the terminal apparatus 20 (coverage 10a is also referred to as a cell). Note that the base station apparatus 10 can accommodate multiple terminal apparatuses 20 in the coverage 10a.

In FIG. 1, an uplink radio communication r30 includes at least the following uplink physical channels. The uplink physical channels are used to transmit information output from a higher layer.
physical uplink control channel (PUCCH)
physical uplink shared channel (PUSCH)
physical random access channel (PRACH)

The PUCCH is a physical channel that is used to transmit Uplink Control Information (UCI). The uplink control information includes positive acknowledgement (ACK)/Negative acknowledgement (NACK) in response to downlink data. Here, the downlink data indicates a Downlink transport block, a Medium Access Control Protocol Data Unit (MAC PDU), a Downlink-Shared Channel (DL-SCH), a Physical Downlink Shared Channel (PDSCH), and the like. The ACK/NACK is also referred to as a Hybrid Automatic Repeat request ACKnowledgement (HARQ-ACK), a HARQ feedback, a HARQ response, or a signal indicating HARQ control information or a delivery confirmation.

An NR supports at least five formats, namely a PUCCH format 0, a PUCCH format 1, a PUCCH format 2, a PUCCH format 3, and a PUCCH format 4. The PUCCH format 0 and the PUCCH format 2 include one or two OFDM symbols, and the other PUCCHs include four to fourteen OFDM symbols. Also, the bandwidth of the PUCCH format 0 and the PUCCH format 1 includes twelve subcarriers. Moreover, in the PUCCH format 0, one bit (or two bits) of ACK/NACK is transmitted in resource elements of twelve subcarriers and one OFDM symbol (or two OFDM symbols).

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel.

In NR, higher layer parameter RI restriction can be configured. There are multiple configuration parameters for the RI restriction, and one of them is a type 1 single panel RI restriction and includes eight bits. The type 1 single panel RI restriction being a bitmap parameter forms a bit sequence r₇, . . . , r₂, r₁. Here, r₇ is a Most Significant Bit (MSB), and r₀ is a Least Significant Bit (LSB). In a case that rᵢ is zero (i is 0, 1, . . . , 7), PMI and RI reporting corresponding to a precoder associated with i+1 layers are not allowed. The RI restriction includes, in addition to the type 1 single panel RI restriction, type 1 multi panel RI restriction, and the type 1 multi panel RI restriction includes four bits. The type 1 multi panel RI restriction being a bitmap parameter forms a bit sequence r₄, r₃, r₂, r₁. Here, r₄ is the MSB, and r₀ is the LSB. In a case that rᵢ is zero (i is 0, 1, 2, 3), PMI and RI reporting corresponding to a precoder associated with the i+1 layers are not allowed.

The CQI can use an index (CQI index) indicative of a preferable modulation scheme (for example, QPSK, 16 QAM, 64 QAM, 256 QAMAM, or the like), a coding rate, and frequency efficiency in a prescribed band. The terminal apparatus selects, from a CQI table, a CQI index considered to allow a transport block of the PDSCH to be received within a block error probability (BLER)=0.1. However, in a case that a prescribed CQI table is configured by higher layer signaling, a CQI index considered to allow reception within BLER=0.00001 is selected from the CQI table.

The PUSCH is a physical channel used to transmit uplink data (an Uplink Transport Block, an Uplink-Shared Channel (UL-SCH)), and CP-OFDM or DFT-S-OFDM is applied as a transmission scheme. The PUSCH may be used to transmit control information such as the HARQ-ACK in response to the downlink data and the channel state information along with the uplink data. The PUSCH may be used to transmit only the channel state information. The PUSCH may be used to transmit only the HARQ-ACK and the channel state information.

The PUSCH is used to transmit Radio Resource Control (RRC) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment specific (user equipment unique) information is transmitted using the signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a power headroom may be included in the MAC CE and may be reported via the PUSCH. In other words, a MAC CE field is used to indicate a level of the power headroom. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used to transmit a random access preamble. The PRACH is used to indicate an initial connection establishment procedure, a handover procedure, a connection re-establishment procedure, synchronization (timing adjustment) of uplink transmission, and a request for the PUSCH (UL-SCH) resource.

In the uplink radio communication, an Uplink Reference Signal (UL RS) is used as an uplink physical signal. The uplink reference signal includes a Demodulation Reference Signal (DMRS), a Sounding Reference Signal (SRS), a Phase Tracking Reference Signal (PTRS), and the like. The DMRS is associated with transmission of the physical uplink shared channel/physical uplink control channel. For example, the base station apparatus 10 uses the demodulation reference signal to perform channel estimation/channel compensation in a case of demodulating the physical uplink shared channel/the physical uplink control channel.

In a case that transform precoding is not applied (is disabled) regarding the PUSCH, a DMRS sequence is generated using a pseudo-random sequence. In contrast, in a case that transform precoding is applied (is enabled) regarding the PUSCH, the DMRS sequence is generated using a low PAPR sequence under conditions other than a prescribed condition. A low PAPR sequence r(n) of a sequence length M_{ZC} (length 36 or larger) is expressed by x_{q}(n mod N_{ZC}). Here, a Zadoff-Chu (ZC) sequence x_{q}(m)=exp(−jπqm(m−1)/N_{ZC}), and N_{ZC} is provided by the largest prime number that satisfies N_{ZC}≤M_{ZC}. In this manner, in a case that the DMRS sequence is generated using the ZC sequence, by cyclically and repeatedly using the ZC sequence of the sequence length N_{ZC}, the DMRS sequence of the sequence length M_{ZC} is generated.

The SRS is not associated with the transmission of the physical uplink shared channel/the physical uplink control channel. The base station apparatus 10 uses the SRS to measure an uplink channel state (CSI Measurement).

The PTRS is associated with transmission of the physical uplink shared channel/physical uplink control channel. The base station apparatus 10 uses the PTRS for phase tracking.

In FIG. 1, at least the following downlink physical channels are used in radio communication of the downlink r31. The downlink physical channels are used to transmit information output from the higher layer.
physical broadcast channel (PBCH)
physical downlink control channel (PDCCH)
physical downlink shared channel (PDSCH)

The PBCH is used to broadcast a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information indicating at least some of a slot number, a subframe number, and a radio frame number in which the PBCH is transmitted.

The PDCCH is used to transmit Downlink Control Information (DCI). The DCI is also referred to as dynamic signaling or L1 signaling. For the downlink control information, multiple formats (also referred to as DCI formats) based on applications are defined. The DCI format may be defined based on the type and the number of bits of the DCI included in a single DCI format. Each format is used depending on the application. The downlink control information includes control information for downlink data transmission and control information for uplink data transmission. The DCI format for downlink data transmission is also referred to as downlink assignment (or downlink grant). The DCI format for uplink data transmission is also referred to as uplink grant (or uplink assignment).

A single downlink assignment is used for scheduling of a single PDSCH in a single serving cell. The downlink grant may be used for at least scheduling of the PDSCH within the same slot as the slot in which the downlink grant has been transmitted. The downlink assignment includes downlink control information, such as frequency domain resource allocation and a time domain resource allocation for the PDSCH, a Modulation and Coding Scheme (MCS) for the PDSCH, a New Data Indicator (NDI) for indicating initial transmission or retransmission, information for indicating the HARQ process number in the downlink, and a Redudancy version for indicating an amount of redundancy added to the codeword during error correction coding. The codeword is data after the error correcting coding. The downlink assignment may include a Transmission Power Control (TPC) command for the PUCCH and a TPC command for the PUSCH. The uplink grant may include an aggregation level (transmission repetition number) for indicating the number of repetitive transmission operations of the PUSCH. Note that the DCI format for each downlink data transmission operation includes information (field) required for the application of the above-described information.

A single uplink grant is used to notify the terminal apparatus of scheduling of a single PUSCH in a single serving cell. The uplink grant includes uplink control information, such as information related to the resource block allocation for transmission of the PUSCH (resource block allocation and hopping resource allocation), time domain resource allocation, information related to the MCS of the PUSCH (MCS/Redundancy version), information related to a DMRS port, information related to retransmission of the PUSCH, a TPC command for the PUSCH, and a request for downlink Channel State Information (CSI) (CSI request). The uplink grant may include information for indicating the HARQ process number in the uplink, information for indicating a redundancy version, a Transmission Power Control (TPC) command for the PUCCH, and a TPC command for the PUSCH. Note that the DCI format for each uplink data transmission includes information (field) required for the application of the above-described information.

An OFDM symbol number (position) for transmitting a DMRS symbol is provided by a period of signaling between the first OFDM symbol in the slot and the last OFDM symbol of the PUSCH resource scheduled in the slot in a case that intra-frequency hopping is not applied and the PUSCH mapping type A is applied. In a case that the intra-frequency hopping is not applied, and the PUSCH mapping type B is applied, the OFDM symbol number (position) for transmitting the DMRS symbol is provided by a scheduled PUSCH resource period. In a case that the intra-frequency hopping is applied, the OFDM symbol number is provided by a period per hop. In regard to the PUSCH mapping type A, a case that the higher layer parameter indicating the number of additional DMRSs is three is supported only in a case that the higher layer parameter indicating the position of the leading DMRS is two. Also, in regard to the PUSCH mapping type A, a four-symbol period is applicable only in a case that the higher layer parameter indicating the position of the leading DMRS is two.

The PDCCH is generated by adding a Cyclic Redundancy Check (CRC) to the downlink control information. In the PDCCH, CRC parity bits are scrambled with a prescribed identity (also referred to as an exclusive OR operation, or a mask). The parity bits are scrambled with a Cell-Radio Network Temporary Identifier (C-RNTI), a Configured Scheduling (CS)-RNTI, a Temporary C-RNTI, a Paging (P)-RNTI, a System Information (SI)-RNTI or a Random Access (RA)-RNTI, a Semi-Persistent Channel State-Information (SP-CSI)-RNTI, or an MCS-C-RNTI. The C-RNTI and the CS-RNTI are identities for identifying a terminal apparatus within a cell. The Temporary C-RNTI is an identity for identifying the terminal apparatus that has transmitted a random access preamble during a contention based random access procedure. The C-RNTI and the Temporary C-RNTI are used to control PDSCH transmission in a single subframe or PUSCH transmission. The CS-RNTI is used to periodically allocate a resource for the PDSCH or the PUSCH. Here, the PDCCH (DCI format) scrambled by the CS-RNTI is used to activate or deactivate the CS type 2. On the other hand, in the CS type 1, control information (such as the MCS and radio resource allocation) included in the PDCCH scrambled by the CS-RNTI is included in a higher layer parameter related to the CS and activates (configures) the CS with the higher layer parameter. The P-RNTI is used to transmit a paging message (Paging Channel (PCH)). The SI-RNTI is used to transmit a SIB. The RA-RNTI is used to transmit a random access response (a message 2 in a random access procedure). The SP-CSI-RNTI is used for semi-static CSI reporting. The MCS-C-RNTI is used in a case that an MCS table with low spectral efficiency is selected.

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to pieces of user equipment in the cell is transmitted using the RRC signaling unique to the cell. The RRC signaling transmitted from the base station apparatus may be a message dedicated to a certain terminal apparatus (also referred to as dedicated signaling). In other words, user equipment specific (user equipment unique) information is transmitted by using the message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals. The downlink physical signals are not used to transmit information output from the higher layers but are used by the physical layer.

The synchronization signal is used for the terminal apparatus to take synchronization of the downlink in the frequency domain and the time domain. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used by the terminal apparatus to measure the downlink channel state (CSI measurement).

The downlink physical channel and the downlink physical signal are also collectively referred to as a downlink signal. In addition, the uplink physical channel and the uplink physical signal are also collectively referred to as an uplink signal. In addition, the downlink physical channel and the uplink physical channel are also collectively referred to as a physical channel. In addition, the downlink physical signal and the uplink physical signal are also collectively referred to as a physical signal.

The BCH, the UL-SCH, and the DL-SCH are transport channels. Channels used in the MAC layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

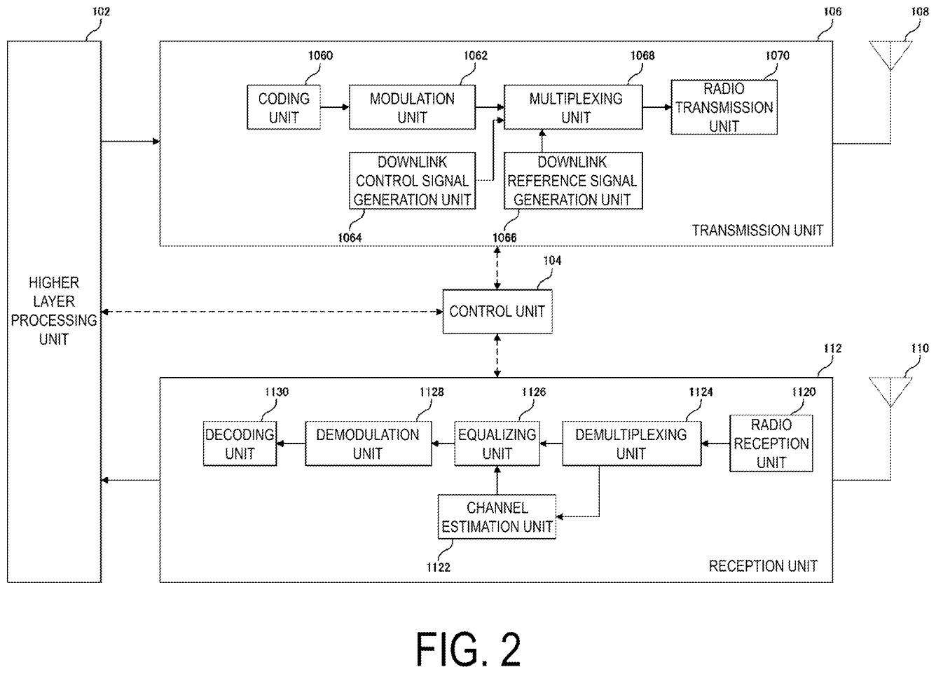

FIG. 2 is a schematic block diagram of a configuration of the base station apparatus 10 according to the present embodiment. The base station apparatus 10 includes a higher layer processing unit (higher layer processing step) 102, a control unit (control step) 104, a transmission unit (transmission step) 106, a transmit antenna 108, a receive antenna 110, and a reception unit (reception step) 112. The transmission unit 106 generates a physical downlink channel in accordance with a logical channel input from the higher layer processing unit 102. The transmission unit 106 includes a coding unit (coding step) 1060, a modulation unit (modulation step) 1062, a downlink control signal generation unit (downlink control signal generation step) 1064, a downlink reference signal generation unit (downlink reference signal generation step) 1066, a multiplexing unit (multiplexing step) 1068, and a radio transmission unit (radio transmission step) 1070. The reception unit 112 detects (demodulates, decodes, or the like) the physical uplink channel and inputs the content to the higher layer processing unit 102. The reception unit 112 includes a radio reception unit (radio reception step) 1120, a channel estimation unit (channel estimation step) 1122, a demultiplexing unit (demultiplexing step) 1124, an equalizing unit (equalizing step) 1126, a demodulation unit (demodulation step) 1128, and a decoding unit (decoding step) 1130.

The higher layer processing unit 102 performs processing on a layer, such as a Medium Access Control (MAC) layer, a Packet Data Convergence Protocol (PDCP) layer, a Radio Link Control (RLC) layer, and a Radio Resource Control (RRC) layer, that is higher than the physical layer. The higher layer processing unit 102 generates information required to control the transmission unit 106 and the reception unit 112, and outputs the resultant information to the control unit 104. The higher layer processing unit 102 outputs the downlink data (such as DL-SCH), the system information (MIB, SIB), and the like to the transmission unit 106. Note that the DMRS structure information may be notified to the terminal apparatus by using the system information (MIB or SIB), instead of the notification by using the higher layer such as RRC.

The higher layer processing unit 102 generates, or acquires from a higher node, the system information (a part of the MIB or the SIB) to be broadcast. The higher layer processing unit 102 outputs the system information to be broadcast to the transmission unit 106 as BCH/DL-SCH. The MIB is allocated to the PBCH in the transmission unit 106. The SIB is allocated to the PDSCH in the transmission unit 106. The higher layer processing unit 102 generates, or acquires from the higher node, the system information (SIB) specific to the terminal apparatus. The SIB is allocated to the PDSCH in the transmission unit 106.

The higher layer processing unit 102 configures various RNTIs for each terminal apparatus. The RNTI is used for encryption (scrambling) of the PDCCH, the PDSCH, and the like. The higher layer processing unit 102 outputs the RNTI to the control unit 104/the transmission unit 106/the reception unit 112.

In a case that the downlink data (transport block, DL-SCH) mapped to the PDSCH, the system information specific to the terminal apparatus (System Information Block (SIB)), the RRC message, the MAC CE, and the DMRS structure information are not notified by using the system information such as the SIB and the MIB, and the DCI, the higher layer processing unit 102 generates, or acquires from a higher node, the DMRS structure information or the like and then outputs the information generated or acquired to the transmission unit 106. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the reception unit 112). The terminal apparatus 20 transmits its own function to the base station apparatus 10 by a higher layer signal (RRC signaling). The information on the terminal apparatus includes information for indicating whether the terminal apparatus supports a prescribed function or information for indicating that the terminal apparatus has completed implementation and testing of the prescribed function. The information for indicating whether the prescribed function is supported includes information for indicating whether the implementation and testing of the prescribed function have been completed.

In a case that the terminal apparatus supports the prescribed function, the terminal apparatus transmits information (parameter) for indicating whether the prescribed function is supported. In a case that the terminal apparatus does not support the prescribed function, the terminal apparatus may be configured not to transmit information (parameter) for indicating whether the prescribed function is supported. In other words, whether the prescribed function is supported is notified by whether information (parameter) for indicating whether the prescribed function is supported is transmitted. Note that the information (parameter) for indicating whether the prescribed function is supported may be notified by using one bit of 1 or 0.

The higher layer processing unit 102 acquires the DL-SCH from the decoded uplink data (including the CRC) from the reception unit 112. The higher layer processing unit 102 performs error detection on the uplink data transmitted by the terminal apparatus. For example, the error detection is performed in the MAC layer.

The control unit 104 controls the transmission unit 106 and the reception unit 112 based on the various kinds of configuration information input from the higher layer processing unit 102/reception unit 112. The control unit 104 generates the downlink control information (DCI) based on the configuration information input from the higher layer processing unit 102/reception unit 112, and outputs the generated downlink control information to the transmission unit 106. For example, the control unit 104 configures, in consideration of the configuration information on the DMRS input from the higher layer processing unit 102/reception unit 112 (whether the configuration is the DMRS structure 1 or the DMRS structure 2), the frequency allocation of the DMRS (an even subcarrier or an odd subcarrier in the case of the DMRS structure 1, and any of the zeroth to the second sets in the case of the DMRS structure 2), and generates the DCI.

The control unit 104 determines the MCS of the PUSCH in consideration of channel quality information (CSI Measurement result) measured by the channel estimation unit 1122. The control unit 104 determines an MCS index corresponding to the MCS of the PUSCH. The control unit 104 includes, in the uplink grant, the MCS index determined.

The transmission unit 106 generates the PBCH, the PDCCH, the PDSCH, the downlink reference signal, and the like in accordance with the signal input from the higher layer processing unit 102/control unit 104. The coding unit 1060 encodes (including repetition) the BCH, the DL-SCH, and the like input from the higher layer processing unit 102 by using a coding scheme predetermined/a coding scheme determined by the higher layer processing unit 102, such as a block code, a convolutional code, a turbo code, a polar coding, an LDPC code, or the like. The coding unit 1060 performs puncturing on the encoded bits based on the coding rate input from the control unit 104. The modulation unit 1062 performs data modulation on the encoded bits input from the coding unit 1060 by using a modulation scheme (modulation order) predefined/a modulation scheme (modulation order) input from the control unit 104, such as the BPSK, the QPSK, the 16 QAM, the 64 QAM, or the 256 QAM. The modulation order is based on the MCS index selected by the control unit 104.

The downlink control signal generation unit 1064 adds the CRC to the DCI input from the control unit 104. The downlink control signal generation unit 1064 encrypts (scrambles) the CRC by using the RNTI. Furthermore, the downlink control signal generation unit 1064 performs QPSK modulation on the DCI to which the CRC is added and generates the PDCCH. The downlink reference signal generation unit 1066 generates a sequence known to the terminal apparatus as the downlink reference signal. The known sequence is determined by a predetermined rule based on a physical cell identity for identifying the base station apparatus 10 and the like.

The multiplexing unit 1068 multiplexes the PDCCHs/downlink reference signals/modulation symbols of the respective channels input from the modulation unit 1062. In other words, the multiplexing unit 1068 maps the PDCCHs/downlink reference signals, modulation symbols of the respective channels to the resource elements. The resource elements to which the mapping is performed are controlled by downlink scheduling input from the control unit 104. The resource element is the minimum unit of a physical resource including one OFDM symbol and one subcarrier. Note that multiple resource elements constitute a resource block (RB), and scheduling is applied with the RB being the minimum unit. Note that, in a case of performing MIMO transmission, the transmission unit 106 includes as many the coding units 1060 and the modulation units 1062 as the number of layers. In this case, the higher layer processing unit 102 configures the MCS for each transport block in the corresponding layer.

The radio transmission unit 1070 performs Inverse Fast Fourier Transform (IFFT) on the multiplexed modulation symbol and the like to generate OFDM symbols. The radio transmission unit 1070 adds cyclic prefixes (CPs) to the OFDM symbols to generate a baseband digital signal. Furthermore, the radio transmission unit 1070 converts the digital signal into an analog signal, removes unnecessary frequency components from the analog signal through filtering, performs up-conversion to a signal of a carrier frequency, performs power amplification, and outputs the resultant signal to the transmit antenna 108 for transmission.

In accordance with an indication from the control unit 104, the reception unit 112 detects (demultiplexes, demodulates, and decodes) the reception signal received from the terminal apparatus 20 through the receive antenna 110, and inputs the decoded data to the higher layer processing unit 102/control unit 104. The radio reception unit 1120 converts the uplink signal received through the receive antenna 110 into a baseband signal by down-conversion, removes unnecessary frequency components from the baseband signal, controls an amplification level so that a signal level is suitably maintained, performs orthogonal demodulation based on an in-phase component and an orthogonal component of the received signal, and converts the resulting orthogonally-demodulated analog signal into a digital signal. The radio reception unit 1120 removes a part corresponding to the CP from the converted digital signal. The radio reception unit 1120 performs Fast Fourier Transform (FFT) on the signal from which the CPs have been removed and extracts a signal in the frequency domain. The signal in the frequency domain is output to the demultiplexing unit 1124.

The demultiplexing unit 1124 demultiplexes the signals input from the radio reception unit 1120 into signals, such as the PUSCH, the PUCCH, and the uplink reference signal, based on uplink scheduling information (such as uplink data channel allocation information) input from the control unit 104. The uplink reference signal resulting from the demultiplexing is input to the channel estimation unit 1122. The PUSCH and PUCCH resulting from the demultiplexing are output to the equalizing unit 1126.

The channel estimation unit 1122 uses the uplink reference signal to estimate a frequency response (or a delay profile). The result of the frequency response that is channel estimated for demodulation is input to the equalizing unit 1126. The channel estimation unit 1122 measures the uplink channel state (measures a Reference Signal Received Power (RSRP), a Reference Signal Received Quality (RSRQ), and a Received Signal Strength Indicator (RSSI)) by using the uplink reference signal. The measurement of the uplink channel state is used to determine the MCS for the PUSCH and the like.

The equalizing unit 1126 performs processing to compensate for an influence in a channel based on the frequency response input from the channel estimation unit 1122. As a method for the compensation, any existing channel compensation, such as a method of multiplying an MMSE weight or an MRC weight or a method of applying an MLD, is applicable. The demodulation unit 1128 performs demodulation processing based on the information on a predetermined modulation scheme/the information on a modulation scheme indicated by the control unit 104.

The decoding unit 1130 performs decoding processing on the output signal from the demodulation unit based on the information on a predetermined coding rate/the information on a coding rate indicated by the control unit 104. The decoding unit 1130 inputs the decoded data (such as the UL-SCH) to the higher layer processing unit 102.

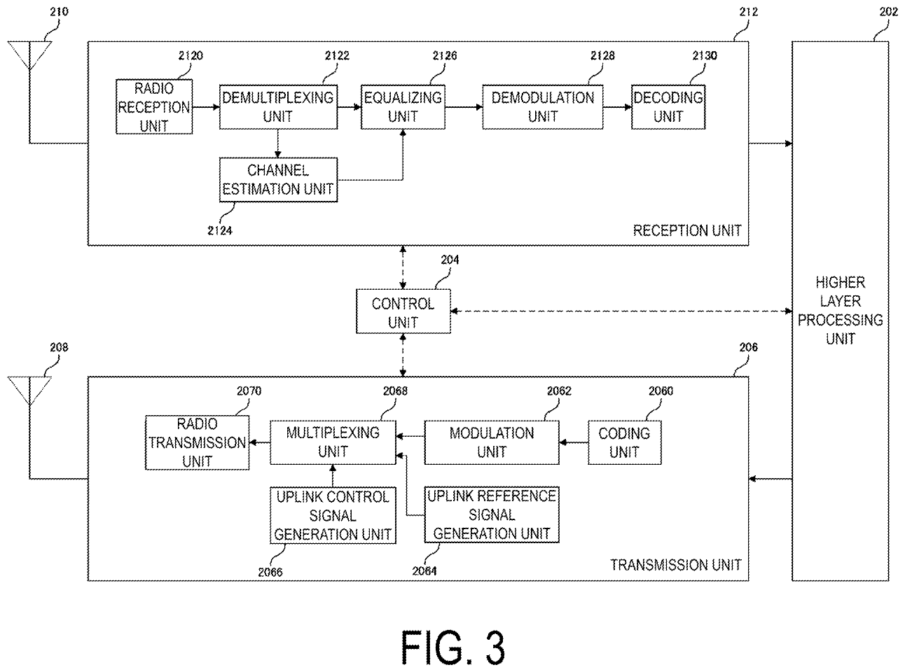

FIG. 3 is a schematic block diagram illustrating a configuration of the terminal apparatus 20 according to the present embodiment. The terminal apparatus 20 includes a higher layer processing unit (higher layer processing step) 202, a control unit (control step) 204, a transmission unit (transmission step) 206, a transmit antenna 208, a receive antenna 210, and a reception unit (reception step) 212.

The higher layer processing unit 202 performs processing of the medium access control (MAC) layer, the packet data convergence protocol (PDCP) layer, the radio link control (RLC) layer, and the radio resource control (RRC) layer. The higher layer processing unit 202 manages various kinds of configuration information of the terminal apparatus itself. The higher layer processing unit 202 notifies the base station apparatus 10 of information for indicating terminal apparatus functions supported by the terminal apparatus itself (UE Capability) via the transmission unit 206. The higher layer processing unit 202 notifies the base station apparatus 10 of the UE Capability by RRC signaling.

The higher layer processing unit 202 acquires the decoded data, such as the DL-SCH and the BCH, from the reception unit 212. The higher layer processing unit 202 generates the HARQ-ACK from a result of the error detection of the DL-SCH. The higher layer processing unit 202 generates the SR. The higher layer processing unit 202 generates the UCI including the HARQ-ACK/SR/CSI (including the CQI report). In a case that the DMRS structure information is notified by the higher layer, the higher layer processing unit 202 inputs the information on the DMRS structure to the control unit 204. The higher layer processing unit 202 inputs the UCI and the UL-SCH to the transmission unit 206. Note that some functions of the higher layer processing unit 202 may be included in the control unit 204.

The control unit 204 interprets the downlink control information (DCI) received via the reception unit 212. The control unit 204 controls the transmission unit 206 in accordance with PUSCH scheduling/MCS index/Transmission Power Control (TPC), and the like acquired from the DCI for uplink transmission. The control unit 204 controls the reception unit 212 in accordance with the PDSCH scheduling/the MCS index and the like acquired from the DCI for downlink transmission. Furthermore, the control unit 204 identifies the frequency allocation of the DMRS according to the information related to the frequency allocation (port number) of the DMRS included in the DCI for downlink transmission and the DMRS structure information input from the higher layer processing unit 202.

The transmission unit 206 includes a coding unit (coding step) 2060, a modulation unit (modulation step) 2062, an uplink reference signal generation unit (uplink reference signal generation step) 2064, an uplink control signal generation unit (uplink control signal generation step) 2066, a multiplexing unit (multiplexing step) 2068, and a radio transmission unit (radio transmission step) 2070.

In accordance with the control by the control unit 204 (in accordance with the coding rate calculated based on the MCS index), the coding unit 2060 encodes the uplink data (UL-SCH) input from the higher layer processing unit 202 by convolutional coding, LDPC coding, polar coding, turbo coding, or the like.

The modulation unit 2062 modulates the encoded bits input from the coding unit 2060 (generates modulation symbols for the PUSCH) with a modulation scheme indicated from the control unit 204, such as BPSK, QPSK, 16 QAM, 64 QAM, and 256 QAM/a modulation scheme predetermined for each channel.

The uplink reference signal generation unit 2064 generates a sequence determined from a predetermined rule (formula), based on a physical cell identity (PCI), which is also referred to as a Cell ID, or the like, for identifying the base station apparatus 10, a bandwidth in which the uplink reference signals are mapped, a cyclic shift, parameter values to generate the DMRS sequence, further the frequency allocation, and the like, in accordance with an indication by the control unit 204.

In accordance with the indication from the control unit 204, the uplink control signal generation unit 2066 encodes the UCI, performs the BPSK/QPSK modulation, and generates modulation symbols for the PUCCH.

In a case that a higher layer parameter (frequencyHopping) regarding the frequency hopping of Rel-15 is configured, a value of the configuration can be configured to mode 1 or mode 2. Mode 2 is a mode for inter-slot hopping in which transmission is performed by changing the frequency for each slot in a case that transmission is performed using multiple slots. On the other hand, mode 1 is a mode for intra-slot hopping in which the slot is divided into a first half and a second half and transmission is performed by changing the frequency in the first half of the slot and the second half of the slot in a case that transmission is performed using one or multiple slots. As frequency allocation in the frequency hopping, the radio resource allocation in the frequency domain notified using the DCI or RRC is applied to a first hop, and in the frequency allocation of a second hop, a radio resource obtained by shifting the radio resource used in the first hop by the value configured by a higher layer parameter (frequencyHoppingOffset) regarding the amount of the frequency hopping is allocated.

The multiplexing unit 2068 multiplexes, for each transmit antenna port (DMRS port), a modulation symbol for the PUSCH, a modulation symbol for the PUCCH, and an uplink reference signal in accordance with uplink scheduling information (a transmission interval in Configured Scheduling (CS) for the uplink included in the RRC message and frequency domain and time domain resource allocation and the like included in the DCI) from the control unit 204 (in other words, each signal is mapped to a resource element).

Here, configured scheduling (CS or configured grant scheduling) will be described. There are two types of transmission without dynamic grant. One is a configured grant type 1 that is provided by the RRC and is stored as a configured grant, and the other one is a configured grant type 2 that is provided by the PDCCH and is stored and cleared as a configured grant based on L1 signaling indicating configured grant activation or configured grant deactivation. The types 1 and 2 are configured by the RRC for each serving cell and for each BWP. The multiple configurations can become active at the same time only in different serving cells. In regard to the type 2, activation and deactivation are independent between serving cells. In regard to the same serving cell, a MAC entity is configured by either the type 1 or the type 2. In a case that the type 1 is configured, the RRC configures the following parameters.
CS-RNTI: CS-RNTI for retransmission
periodicity: a periodicity of the configured grant type 1
timeDomainOffset: an offset of a resource related to SFN=0 in the time domain
timeDomainAllocation: allocation of a configured grant in the time domain including a parameter startSymbolAndLength
nrofHARQ-Processes: the number of HARQ processes

In a case that the type 2 is configured, the RRC configures the following parameters.
cs-RNTI: CS-RNTI for activation, deactivation, and retransmission
periodicity: a periodicity of the configured grant type 2
nrofHARQ-Processes: the number of HARQ processes

In other words, ConfiguredGrantConfig is used to configure uplink transmission without dynamic grant in accordance with the two schemes. The actual uplink grant is configured via the RRC for the Configured Grant type 1 and is provided via the PDCCH processed by the CS-RNTI for the Configured Grant Type 2.

As described above, by reducing a PAPR of a time waveform of a transmission signal, an inexpensive amplifier can be used. In DFT-S-OFDM, by applying DFT precoding, the PAPR can be significantly reduced in comparison to CP-OFDM. In DFT-S-OFDM, M-point DFT precoding is applied to a symbol sequence of the sequence length M, an obtained M-point frequency spectrum is mapped to one of N_{c} (M<N_{c}) points, and zero is assigned to points (subcarriers) not subjected to the mapping. Subsequently, an N_{c} (M<N_{c})-point IFFT is applied, and a time domain signal is thereby obtained. In this case, subcarriers adjacent to the M points subjected to the mapping are zero (null subcarriers). In this manner, sudden loss of amplitude of a spectrum in the frequency domain means that a frequency domain rectangular filter is multiplied. Multiplication of a rectangular filter in the frequency domain is equivalent to convolution operation of a Sinc function in the time domain. In other words, in a case that the bandwidth of the rectangular filter is narrow, this may cause increase of the PAPR of the time domain signal due to the convolution operation of the Sinc function. In order to reduce the influence of the rectangular filter, application of a filter with a smooth shape, such as a Nyquist filter, is considered. In a case that the Nyquist filter is multiplied in the frequency domain, a part of a signal disappears, and transmission characteristics deteriorate. In view of this, in NPL 1, the frequency spectrum is cyclically extended in the frequency domain, and then the filter is multiplied. Although a part of the spectrum disappears due to multiplication of the filter, the reduced spectrum is to be transmitted in extended subcarriers, and thus a data signal can be transmitted using the same power as that in a case that bandwidth extension and frequency domain filtering are not applied. Despite that a wide bandwidth needs to be used in comparison to a case that bandwidth extension is not applied, the PAPR can be reduced.

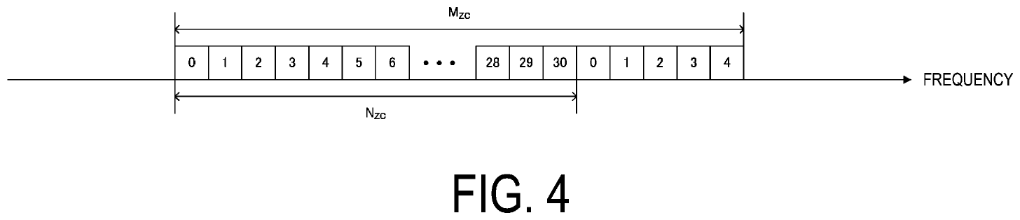

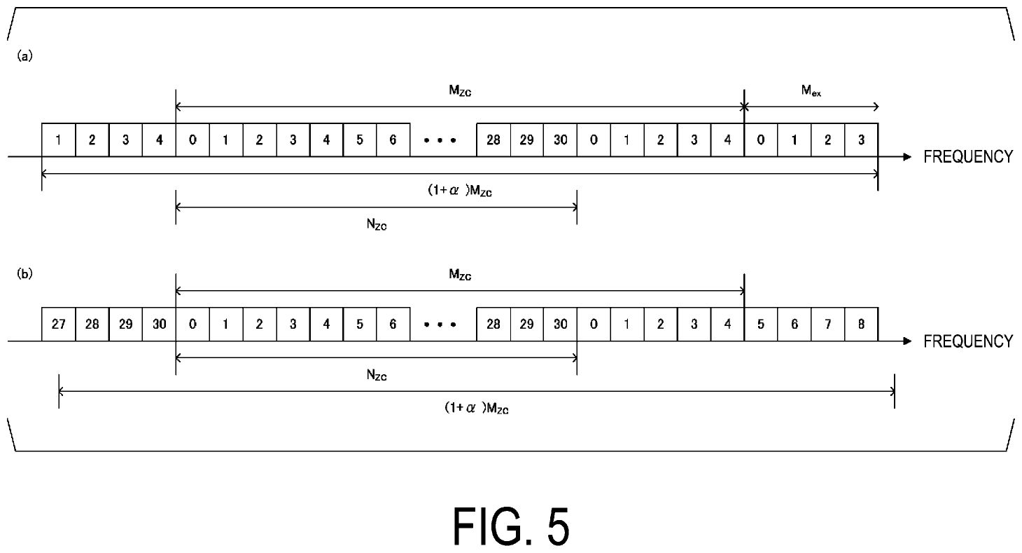

The bandwidth extension and the frequency domain filtering described above can be applied not only to the data signal but also to the DMRS. Note that, although the DMRS will be taken as an example in description, the bandwidth extension and the frequency domain filtering can also be applied to an uplink reference signal other than the DMRS and other signals, such as a Sounding RS (SRS) and a synchronization signal and a control signal such as a PUCCH. As described above, in NR, in a case that transform precoding is applied (is enabled) regarding the PUSCH, the DMRS sequence is generated using the low PAPR sequence in the uplink reference signal generation unit under conditions other than a prescribed condition. The low PAPR sequence is generated by cyclically extending the ZC sequence x_{q}(m)=exp(−jπqm(m−1)/N_{ZC}), where M_{ZC} is the number of allocation subcarriers and m=0, 1, 2, . . . , M_{ZC}−1. Note that, here, the number of allocation subcarriers represents the number of subcarriers with amplitude other than zero in the entire allocation bandwidth, instead of that in the entire allocation bandwidth. For example, in a case of DMRS configuration type 1, a spectrum having energy (amplitude) is transmitted using only even-numbered or odd-numbered subcarriers in the entire allocation bandwidth, and thus the number of subcarriers in the entire allocation bandwidth is 2M_{ZC}, and the number of non-zero allocation subcarriers is M_{ZC}. The number of subcarriers in the entire allocation bandwidth and the DMRS configuration type are transmitted as the control information transmitted by the base station apparatus. Note that the DMRS configuration type may be configured in a system in advance. In a case that the number of subcarriers is M_{ZC}, N_{ZC} is provided by the largest prime number that satisfies N_{ZC}≤M_{ZC}. FIG. 4 illustrates an example in a case that M_{ZC}=36. In a case that M_{ZC}=36, N_{ZC}=31. Thus, with the sequence of sequence length 31 of x_{q}(0) to x_{q}(30) being a reference, by cyclically extending the sequence of x_{q}(0) to x_{q}(4) to x_{q}(0) to x_{q}(30), the DMRS sequence of sequence length 36 is obtained. In this manner, in a case that the DMRS sequence is generated using the ZC sequence, by cyclically and repeatedly using the ZC sequence of the sequence length N_{ZC}, the DMRS sequence of the sequence length M_{ZC} is generated. According to NPL 2, in a case that bandwidth extension and frequency domain filtering are applied to the DMRS, by applying cyclic extension to the DMRS sequence of the length M_{ZC} obtained by cyclically extending the ZC sequence of the length N_{ZC}, the DMRS sequence of length (1+α)M_{ZC} is obtained. α is hereinafter referred to as a bandwidth extension rate. FIG. 5(a) illustrates an example. The figure is an example of a case that M_{ZC}=36, N_{ZC}=31, and α=0.22 . . . . Similarly to the method of generating the DMRS in NR, the DMRS sequence x_{q}(0), x_{q}(1), . . . , x_{q}(30), x_{q}(0), x_{q}(1), . . . , x_{q}(4) of a length of M_{ZC}=36 before bandwidth extension is generated. Subsequently, by cyclically extending the DMRS sequence of the length of M_{ZC}=36, the DMRS sequence x_{q}(0), x_{q}(1), . . . , x_{q}(4), x_{q}(0), x_{q}(1), . . . , x_{q}(30), x_{q}(0), x_{q}(1), . . . , x_{q}(4), x_{q}(0), x_{q}(1), x_{q}(2), x_{q}(3) of (1+α)M_{ZC}=44 is generated. By applying frequency domain filtering to the obtained DMRS sequence of the length (1+α)M_{ZC}, bandwidth extension and frequency domain filtering can also be applied to the DMRS. However, as illustrated in FIG. 5(a), a non-cyclic portion, that is, a discontinuous portion, is present in the sequence. In FIG. 5(a), there are two of such portions, each of which is a non-cyclic portion present between x_{q}(4) and x_{q}(0), that is, a portion between an extended bandwidth and a bandwidth before extension. With such non-cyclic portions being included in the sequence, characteristics of the low PAPR of the original ZC sequence are deteriorated, and the PAPR of the time waveform is increased. In view of this, in NPL 2, by applying cyclic extension to the ZC sequence of the length N_{ZC}, the DMRS sequence of the length (1+α)M_{ZC} is generated. FIG. 5(b) illustrates a proposition in NPL 2. In FIG. 5(b), by generating the ZC sequence x_{q}(0), x_{q}(1), . . . , x_{q}(30) based on N_{ZC}=31 calculated from M_{ZC}=36 and applying cyclic extension to the ZC sequence, the DMRS sequence x_{q}(27), x_{q}(28), x_{q}(29), x_{q}(30), x_{q}(0), x_{q}(1), . . . , x_{q}(29), x_{q}(30), x_{q}(0), x_{q}(1), . . . , x_{q}(8) having a length of (1+α)M_{ZC}=44 is generated. By generating the DMRS as described in NPL 2, there are no longer discontinuous portions (portions in which the sequence is not cyclic extension of the ZC sequence) in the DMRS sequence of the sequence length (1+α)M_{ZC}, and thus the PAPR can be reduced.

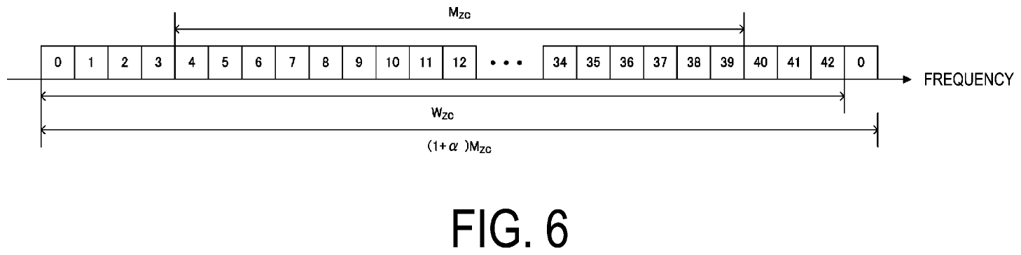

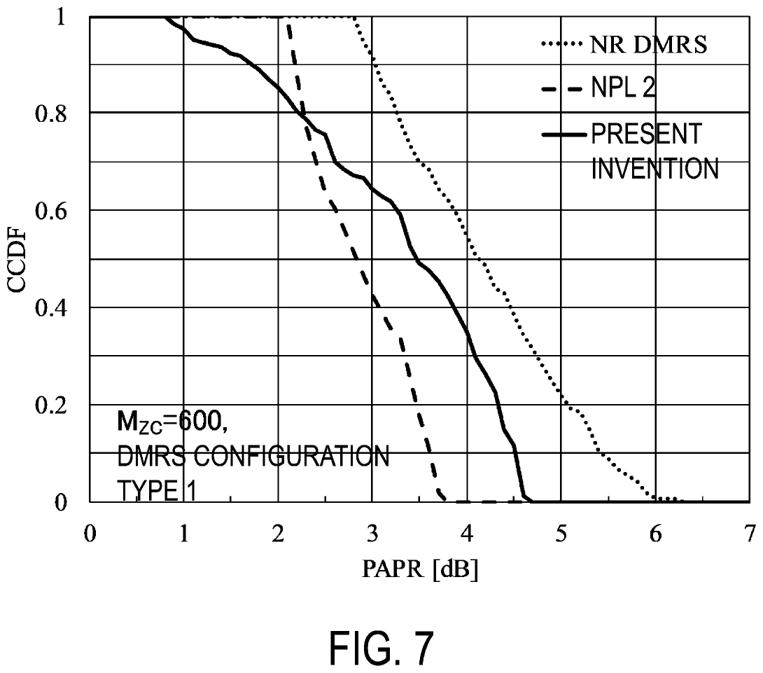

However, in the method proposed in NPL 2, by generating the ZC sequence of the sequence length of N_{ZC} based on M_{ZC} and cyclically using the generated ZC sequence, the sequence of the length (1+α)M_{ZC} is generated. Thus, the ZC sequence is repeatedly used in the sequence length of (1+α)M_{ZC}, and accordingly the PAPR cannot be efficiently reduced. For example, in FIG. 5(b), x_{q}(27), x_{q}(28), x_{q}(29), x_{q}(30), x_{q}(0), x_{q}(1), . . . , x_{q}(8) appears twice in the frequency domain. In the present embodiment, by generating the longest possible ZC sequence based on the number of subcarriers after extension calculated from the number of allocation subcarriers and the bandwidth extension rate, the PAPR is reduced. In other words, the ZC sequence is generated based on the bandwidth (1+α)M_{ZC} after extension. In NPL 2, the ZC sequence having the sequence length of N_{ZC} being the largest prime number not exceeding M_{ZC} is generated based on the bandwidth M_{ZC} before extension, whereas in the present embodiment, the ZC sequence having the sequence length of W_{ZC} (N_{ZC}≤W_{ZC}≤(1+α)M_{ZC}) being the largest prime number not exceeding (1+α)M_{ZC} is generated based on the bandwidth (1+α)M_{ZC} after extension. With this, the DMRS can be generated using the ZC sequence, which is the longest sequence within a range of the bandwidth after extension. FIG. 6 illustrates an example in the present embodiment. In FIG. 6, (1+α)M_{ZC}=44 is calculated from M_{ZC}=36 and α=0.22 . . . , and the ZC sequence x_{q}(0), x_{q}(1), . . . , x_{q}(41), x_{q}(42) is generated using W_{ZC}=43 being the largest prime number not exceeding 44. By applying cyclic extension to the generated ZC sequence of length 43, the DMRS sequence x_{q}(0), x_{q}(1), . . . , x_{q}(41), x_{q}(42), x_{q}(0) of length 44 is generated. By generating the ZC sequence using the bandwidth after bandwidth extension as described above, the number of elements of the ZC sequence transmitted multiple times can be reduced. In FIG. 6, only x_{q}(0) is transmitted twice, and other elements are transmitted only once, and therefore the PAPR can be reduced. FIG. 7 illustrates computer simulation results. In the figure, α=0.24, M_{ZC}=600, and DMRS configuration type 1 is employed. A complementary cumulative distribution function (CCDF) is acquired, based on an assumption that parameters q of respective ZC sequences are selected with equal probability. DMRS configuration type 1 is a configuration type in which the ZC sequence is mapped only to odd-numbered or even-numbered subcarriers and subcarriers to which ZC is not mapped are zero (null carriers). With reference to FIG. 7, with the proposition in NPL 2, it can be understood that the PAPR of the DMRS can be reduced in comparison to the DMRS of NR to which bandwidth extension and frequency domain filtering are not applied. With the invention of the present embodiment as well, similarly to the proposition in NPL 2, it can be understood that the PAPR of the DMRS can be reduced in comparison to the DMRS of NR to which bandwidth extension and frequency domain filtering are not applied. It can be understood that, in a case that the invention of the present embodiment and the proposition in NPL 2 are compared, the lowest PAPR sequence is obtained in the invention of the present embodiment. In this manner, according to the invention, a large number of sequences indicating the PAPR lower than that of the proposition in NPL 2 can be configured.

In order to generate the DMRS as described above, the bandwidth extension rate a needs to be configured in the terminal apparatus. The bandwidth extension rate a is notified as the control information from the base station apparatus, using higher layer or dynamic signaling. The bandwidth extension rate a may be quantized, and one of multiple quantized candidates may be notified. Note that the bandwidth extension rate a may be determined in advance, and application/no application of bandwidth extension may be notified using higher layer or dynamic signaling. In this case, in the radio resource allocation notified from the base station apparatus, M_{ZC} may be notified, or (1+α)M_{ZC} after bandwidth extension may be notified. Unlike the above configuration in which the bandwidth extension rate α is directly notified from the base station apparatus to the terminal apparatus, the parameter M_{ZC} indicating resource allocation and a bandwidth extension range Mₑₓ may be notified. Because the bandwidth extension rate a is Mₑₓ/M_{ZC}, with the parameter M_{ZC} indicating resource allocation and the bandwidth extension range Mₑₓ being notified, an appropriate bandwidth extension rate a depending on a communication environment can be configured. Here, the bandwidth extension range Mₑₓ may be configured in the unit of the resource block. In a case that the bandwidth extension rate α is a quantized value, by rounding up, rounding down, or rounding off the calculated value, processing may be limited only within prescribed resource blocks. Note that, although the above description presupposes configuration of α with the resource block being a reference, the bandwidth extension may be performed in the unit of the subcarrier instead of the unit of the resource block. In high frequencies such as millimeter waves and terahertz waves, interference between cells may not be a problem. Thus, ZC may be generated not with the sequence length of a prime number but with an odd number.

On the condition that a sequence is appropriately selected, the ZC sequence has the PAPR lower than that of a data signal using QPSK, π/2 shift BPSK (π/2-BPSK), or the like. Therefore, the same bandwidth extension rate α need not be configured between the data signal and the DMRS, and the PAPR equivalent to or lower than that of the data signal may be implemented in a bandwidth narrower than bandwidth extension for the data signal. For example, apart from the bandwidth extension rate α for a data signal, a bandwidth extension rate α_{DMRS} for a DMRS may be notified from the base station apparatus to the terminal apparatus, using higher layer or dynamic signaling. Although any type of filtering may be used as frequency domain filtering (also referred to as spectrum formation), a raised-cosine filter is generally used as the Nyquist filter. In order to satisfy a Nyquist condition with a transmission filter, a channel, and a reception filter, a root raised-cosine filter may be applied on each of a transmission side and a reception side, and the Nyquist filter may be formed in the whole system.

The radio transmission unit 2070 performs Inverse Fast Fourier Transform (IFFT) on the multiplexed signals to generate OFDM symbols. The radio transmission unit 2070 adds CPs to the OFDM symbols to generate a baseband digital signal. Furthermore, the radio transmission unit 2070 converts the baseband digital signal into an analog signal, removes unnecessary frequency components from the analog signal, converts the signal into a signal of a carrier frequency by up-conversion, performs power amplification, and transmits the resultant signal to the base station apparatus 10 via the transmit antenna 208.

The reception unit 212 includes a radio reception unit (radio reception step) 2120, a demultiplexing unit (demultiplexing step) 2122, a channel estimation unit (channel estimation step) 2144, an equalizing unit (equalizing step) 2126, a demodulation unit (demodulation step) 2128, and a decoding unit (decoding step) 2130.

The radio reception unit 2120 converts the downlink signal received through the receive antenna 210 into a baseband signal by down-conversion, removes unnecessary frequency components from the baseband signal, controls an amplification level so that a signal level is suitably maintained, performs orthogonal demodulation based on an in-phase component and an orthogonal component of the received signal, and converts the resulting orthogonally-demodulated analog signal into a digital signal. The radio reception unit 2120 removes a part corresponding to the CP from the digital signal resulting from the conversion, performs the FFT on the signal from which the CP has been removed, and extracts a signal in the frequency domain.

The demultiplexing unit 2122 demultiplexes the extracted signal in the frequency domain into the downlink reference signal, the PDCCH, the PDSCH, and the PBCH. A channel estimation unit 2124 uses the downlink reference signal (such as the DM-RS) to estimate a frequency response (or delay profile). The result of the frequency response that is channel estimated for demodulation is input to the equalizing unit 1126. The channel estimation unit 2124 measures the uplink channel state (measures a Reference Signal Received Power (RSRP), a Reference Signal Received Quality (RSRQ), a Received Signal Strength Indicator (RSSI), and a Signal to Interference plus Noise power Ratio(SINR)) by using the downlink reference signal (such as the CSI-RS). The measurement of the downlink channel state is used to determine the MCS for the PUSCH and the like. The measurement result of the downlink channel state is used to determine the CQI index and the like.

The equalizing unit 2126 generates an equalization weight based on an MMSE criterion using the frequency response input from the channel estimation unit 2124. The equalizing unit 2126 multiplies the input signal (the PUCCH, the PDSCH, the PBCH, and the like) from the demultiplexing unit 2122 by the equalization weight. The demodulation unit 2128 performs demodulation processing based on information of the predetermined modulation order/information of the modulation order indicated by the control unit 204.

The decoding unit 2130 performs decoding processing on the output signal from the demodulation unit 2128 based on information of the predetermined coding rate/information of the coding rate indicated by the control unit 204. The decoding unit 2130 inputs the decoded data (such as the DL-SCH) to the higher layer processing unit 202.

### Modification of First Embodiment

The first embodiment describes a method of generating the ZC sequence, based on an extended bandwidth. However, because frequency domain filtering is applied, transmission is performed with a part of the spectrum being reduced, and thus the PAPR may be increased. In the present embodiment, a method of generating the ZC sequence in a case of performing bandwidth extension will be described.

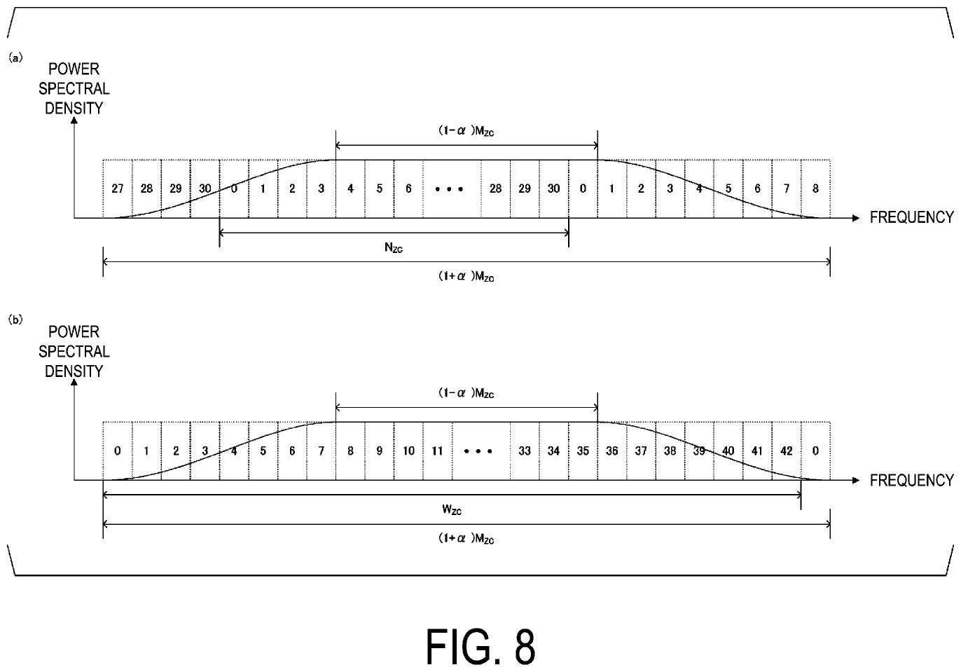

FIG. 8 illustrates a conceptual diagram of a case that bandwidth extension and frequency domain filtering are applied. FIG. 8(a) illustrates the proposition in NPL 2, and FIG. 8(b) illustrates the invention in the first embodiment. As can be understood from the figure, by applying frequency domain filtering, it can be understood that energy of the spectrum is reduced. For example, in FIG. 8(b), it can be understood that transmission is performed with energy of x_{q}(0), x_{q}(1), x_{q}(2), x_{q}(41), x_{q}(42) being considerably reduced. As described in the first embodiment, in a case that the ZC sequence is performed based on (1+α)M_{ZC}, a part of the sequence is reduced, which results in increase of the PAPR. In contrast, regarding the spectrum at center (1−α)M_{ZC} of FIG. 8, transmission is not performed with energy of the spectrum being reduced. It is considered that, by generating the ZC sequence of a sequence length L_{ZC} using the largest prime number L_{ZC} (L_{ZC}≤N_{ZC}) not exceeding (1−α)M_{ZC} and cyclically extending the obtained sequence length L_{ZC}, the DMRS sequence of the sequence length (1+α)M_{ZC} is generated. However, there is a problem in that repetitive mapping of the ZC sequence having a short sequence length in the frequency domain increases the PAPR of the time waveform. In other words, an appropriate value exists as a reference for generating the ZC sequence in a case that bandwidth extension and frequency domain filtering are applied. However, as illustrated in FIG. 7, in a case that the sequence length is increased, although the number of sequences having a low PAPR is increased, the number of sequences having a high PAPR is increased as well. Thus, depending on whether the base station apparatus requires a large number of sequences having a low PAPR, and whether control can be performed so that a sequence having a low PAPR can be selected, an appropriate method of generating the ZC sequence differs. In other words, in a case that the base station apparatus requires a large number of sequences having a low PAPR and control can be performed so that a sequence having a low PAPR can be selected, the ZC sequence with a long sequence should be generated, whereas in a case that the base station apparatus does not require a large number of sequences having a low PAPR or control for selecting a sequence having a low PAPR cannot be performed, the ZC sequence with a short sequence should be generated. As described above, an appropriate method of generating the ZC sequence differs depending on a communication state of neighboring cells and operation of the base station apparatus, and thus in a case that bandwidth extension and frequency domain filtering are applied, it is desirable to separately give notification of a reference for generating the ZC sequence. In view of this, information related to the reference for generating the ZC sequence may be notified together with radio resources. For example, the generated ZC sequence itself may be notified, or a minimum number of resource blocks exceeding the sequence length to be generated may be notified with the number of subcarriers included in one resource block being 12, for example.

Note that, although the resource block is used as a reference in the above description, frequency domain filtering may be applied without the resource block being used as a reference. In other words, the number of resource blocks before bandwidth extension is notified from the base station apparatus to the terminal apparatus, but the bandwidth of the signal after frequency domain filtering may be formed with the bandwidth not being necessarily caused to match an integer multiple of the resource blocks (for example, 12 subcarriers). Alternatively, in a case that the number of resource blocks after bandwidth extension is notified from the base station apparatus to the terminal apparatus, the bandwidth of the signal before frequency domain filtering need not be necessarily caused to match an integer multiple of the resource blocks (for example, 12 subcarriers). Note that information of the bandwidth not being an integer of the resource blocks is defined in a system in advance or is notified using control information of a higher layer or the like.

### Other Examples of First Embodiment

In the first embodiment and the second embodiment, description is given based on specifications (NR) of 3GPP, but application is also possible for communication standards other than NR. For example, single carrier transmission is employed in IEEE 802.11ad, and application is possible for bandwidth extension in single carrier transmission. The above description concerns single carrier transmission such as DFT-S-OFDM, but application is also possible for multi-carrier transmission such as OFDM. In addition, application is also possible for a single carrier spectrum such as Clustered DFT-S-OFDM, but bandwidth extension may be limited to a case that the spectrum is continuously mapped, including multi-carrier transmission as well.

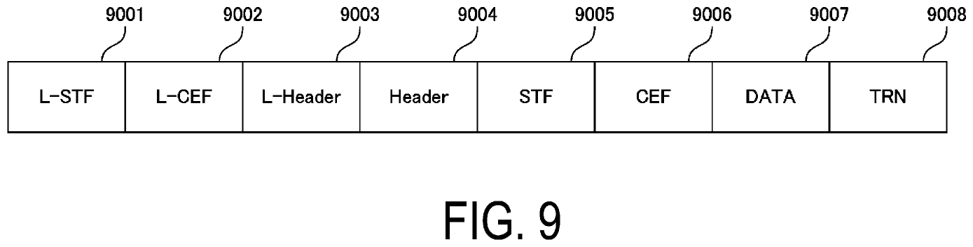

FIG. 9 is an overview diagram illustrating an example of a transmission frame format according to the present embodiment. As illustrated in FIG. 9, the base station apparatus (and the terminal apparatus) according to the present embodiment can transmit a frame at least including a legacy short training field (L-STF), a legacy channel estimation field (L-CEF, a first reference signal), a legacy header field (L-Header), a header field (Header), a short training field (STF), a channel estimation field (CEF, a second reference signal), a data field (DATA), and a training sequence field (TRN). Here, the L-STF, the L-CEF, and the L-Header are fields for maintaining backward compatibility and are fields that can be recognized by a radio apparatus of backward specifications supported by the communication system to which the present embodiment is applied. The CEF is a field for channel estimation supported by the communication system to which the present embodiment is applied.

The base station apparatus (and the terminal apparatus) according to the present embodiment can cyclically extend such a frequency spectrum as that described above in the first embodiment and the second embodiment for the CEF in the frequency domain and can then configure a communication method of multiplying the filter. Note that the base station apparatus (and the terminal apparatus) according to the present embodiment can apply different signal sequences to the L-CEF and the CEF. For example, the base station apparatus (and the terminal apparatus) according to the present embodiment can configure a sequence obtained by applying pi/2 shift BPSK modulation to a bit sequence including 0 and 1 for the L-CEF and can configure the ZC sequence for the CEF.

The base station apparatus (and the terminal apparatus) according to the present embodiment can cyclically extend the above-described frequency spectrum for the radio apparatus belonging to a basic service set (BSS) controlled by the apparatuses in the frequency domain, and can then broadcast information indicating whether the apparatuses transmit a frame configured with the communication method of multiplying the filter, using a beacon frame or the like. In a case that the terminal apparatus attempts connection to a certain BSS, the apparatus can cyclically extend the frequency spectrum in the frequency domain and can then transmit a frame including information indicating whether the apparatus can receive the frame configured with the communication method of multiplying the filter.

The base station apparatus (and the terminal apparatus) according to the present embodiment can reduce the PAPR of the CEF by cyclically extending the frequency spectrum for the CEF in the frequency domain and then configuring the communication method of multiplying the filter. In contrast, for the L-CEF, because the radio apparatus of backward specifications supported by the communication system to which the present embodiment is applied needs to be capable of recognizing, the communication method of multiplying the filter is not configured after the frequency spectrum is cyclically extended in the frequency domain. This suggests that the base station apparatus (and the terminal apparatus) according to the present embodiment can transmit signals of different frequency bandwidths between the L-CEF and the CEF. This suggests that the base station apparatus (and the terminal apparatus) according to the present embodiment can configure signal sequences of different lengths between the L-CEF and the CEF. This is for the following reason: In a case that the frequency spectrum is cyclically extended for the L-CEF and then the communication method of multiplying the filter is configured in the frequency domain, the radio apparatus of backward specifications cannot recognize that the frequency spectrum is extended more than a known L-CEF and cannot recognize that the frequency spectrum is multiplied by the filter, and thus received quality of the legacy header to be decoded by the radio apparatus of backward specifications based on the L-CEF is reduced.

It is assumed that the base station apparatus (and the terminal apparatus) according to the present embodiment performs demodulation based on the L-CEF, regarding the header field. Thus, the base station apparatus (and the terminal apparatus) according to the present embodiment can configure the communication method of multiplying the filter after cyclically extending the frequency spectrum for the header field in the frequency domain.

In a case that the base station apparatus (and the terminal apparatus) according to the present embodiment performs frame transmission based on a frame (for example, a trigger frame) triggering frame transmission, the base station apparatus (and the terminal apparatus) can cyclically extend the frequency spectrum for the frame to be transmitted in the frequency domain, based on information described in the frame triggering frame transmission, and can then determine whether to configure the communication method of multiplying the filter. The base station apparatus (and the terminal apparatus) according to the present embodiment can cyclically extend the frequency spectrum for the frame to be transmitted in the frequency domain, based on a frame type of the frame to be transmitted, and can then determine whether to configure the communication method of multiplying the filter.

Note that, in a case that the bandwidth of the frequency spectrum differs between the CEF and the L-CEF, the base station apparatus (and the terminal apparatus) according to the present embodiment can configure a spectrum mask to be applied in a case of transmitting the CEF for transmission of the L-CEF. This is not limited to the L-CEF, and in a case that the bandwidth of the frequency spectrum of the field to be transmitted differs, the base station apparatus (and the terminal apparatus) according to the present embodiment can transmit the frame, using the spectrum mask to be applied to the field having the widest bandwidth.

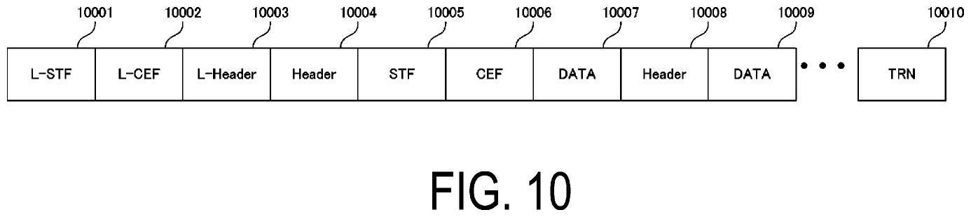

As illustrated in FIG. 10, for the purpose of reducing overhead, the base station apparatus (and the terminal apparatus) according to the present embodiment can transmit the frame, based on frame aggregation of combining the header field and the DATA. In this case, regarding second and later header fields 10008, demodulation can be performed based on a CEF 10006, and thus the communication method of multiplying the filter can be configured after performing cyclic extension in the frequency domain. In other words, in a case that the base station apparatus (and the terminal apparatus) according to the present embodiment applies frame aggregation, the base station apparatus (and the terminal apparatus) can configure different communication methods for a first header 10004 (first control signal field) and a second header 10008 (second control signal field). Specifically, the base station apparatus (and the terminal apparatus) according to the present embodiment can configure the bandwidth of the frequency spectrum of the first control signal field to be the same as the L-CEF and the bandwidth of the frequency spectrum of the second control signal field to be the same as the CEF.

Note that the base station apparatus (and the terminal apparatus) according to the present embodiment can also configure the communication method of multiplying the filter after cyclically extending the frequency spectrum of the signal for channel estimation in the frequency domain for the L-CEF. In this case, the base station apparatus (and the terminal apparatus) according to the present embodiment can perform configuration not only for a signal spectrum of the L-CEF but also for other fields (for example, the legacy short training field, the legacy header field, and a legacy portion) that can be recognized by the radio apparatus of backward specifications supported by the communication system to which the present embodiment is applied. However, as described above, in a case that the communication method of multiplying the filter is configured after the frequency spectrum of a signal for channel estimation is cyclically extended in the frequency domain for the L-CEF, received quality of the legacy header is reduced. Accordingly, in order not to reduce the received quality of the legacy header to be decoded by the radio apparatus of backward specifications based on the L-CEF, the base station apparatus (and the terminal apparatus) according to the present embodiment can reduce a roll-off factor a of the filter to be applied to the L-CEF and the legacy header to be smaller than that of the filter to be applied to the CEF.

A program that operates on an apparatus according to the present invention may serve as a program that controls a Central Processing Unit (CPU) and the like to cause a computer to operate in such a manner as to implement the functions of the above-described embodiment according to the present invention. Programs or the information handled by the programs are temporarily loaded into a volatile memory such as a Random Access Memory (RAM) while being processed, or stored in a non-volatile memory such as a flash memory, or a Hard Disk Drive (HDD), and then read, modified, and written by the CPU, as necessary.

Note that the apparatuses in the above-described embodiments may be partially implemented by a computer. In that case, a program for implementing the functions of the embodiments may be recorded on a computer readable recording medium. It may be implemented by causing a computer system to read and execute the program recorded on this recording medium. It is assumed that the “computer system” refers to a computer system built into the apparatuses, and the computer system includes an operating system and hardware components such as a peripheral device. Furthermore, the “computer readable recording medium” may be any of a semiconductor recording medium, an optical recording medium, a magnetic recording medium, and the like.

Moreover, the “computer readable recording medium” may include a medium that dynamically retains a program for a short period of time, such as a communication wire that is used for transmission of the program over a network such as the Internet or over a communication line such as a telephone line, and may also include a medium that retains a program for a certain period of time, such as a volatile memory within the computer system for functioning as a server or a client in a case that the program is transmitted via the communication wire. The above-described program may be one for implementing a part of the above-described functions, and also may be one capable of implementing the above-described functions in combination with a program already recorded in a computer system.

Furthermore, each functional block or various characteristics of the apparatuses used in the above-described embodiments may be implemented or performed with an electric circuit, that is, typically an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The above-mentioned electric circuit may include a digital circuit or may include an analog circuit. Furthermore, in a case that with advances in semiconductor technology, a circuit integration technology appears that replaces the present integrated circuits, it is also possible to use an integrated circuit based on the technology.

Note that, the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that does not depart from the gist of the present invention. Furthermore, in the present invention, various modifications are possible within the scope of claims, and embodiments that are made by suitably combining technical means disclosed according to the different embodiments are also included in the technical scope of the present invention. A configuration in which elements described in the respective embodiments and having mutually the similar effects, are substituted for one another is also included.

### INDUSTRIAL APPLICABILITY

The present invention can be preferably used in a base station apparatus, a terminal apparatus, and a communication method.

### REFERENCE SIGNS LIST

10 Base station apparatus
20 Terminal apparatus
10a Range within which base station apparatus 10 is connectable to terminal apparatus
102 Higher layer processing unit
104 Control unit
106 Transmission unit
108 Transmit antenna
110 Receive antenna
112 Reception unit
1060 Coding unit
1062 Modulation unit
1064 Downlink control signal generation unit
1066 Downlink reference signal generation unit
1068 Multiplexing unit
1070 Radio transmission unit
1120 Radio reception unit
1122 Channel estimation unit
1124 Demultiplexing unit
1126 Equalizing unit
1128 Demodulation unit
1130 Decoding unit
202 Higher layer processing unit
204 Control unit
206 Transmission unit
208 Transmit antenna
210 Receive antenna
212 Reception unit
2060 Coding unit
2062 Modulation unit
2064 Uplink reference signal generation unit
2066 Uplink control signal generation unit
2068 Multiplexing unit
2070 Radio transmission unit
2120 Radio reception unit
2122 Demultiplexing unit
2124 Channel estimation unit
2126 Equalizing unit
2128 Demodulation unit
2130 Decoding unit

1. A terminal apparatus configured to perform communication with a base station apparatus, the terminal apparatus comprising:
an uplink reference signal generation unit configured to generate an uplink reference signal; and
a reception unit configured to receive control information at least including the number of allocation subcarriers, information related to bandwidth extension, and information related to a configuration type of the uplink reference signal, the control information being transmitted from the base station apparatus,
wherein the uplink reference signal generation unit generates, by generating a Zadoff-Chu sequence based on the number of subcarriers after extension calculated based at least on the number of the allocation subcarriers, the information related to the bandwidth extension, and the information related to the configuration type of the uplink reference signal and cyclically extending the generated Zadoff-Chu sequence, the uplink reference signal sequence having a sequence length whose number is equal to the number of the subcarriers after extension.

2. The terminal apparatus according to claim 1,
wherein a sequence length of the Zadoff-Chu sequence is generated using a largest prime number not exceeding the number of the subcarriers after extension.

3. The terminal apparatus according to claim 1,
wherein a sequence length of the Zadoff-Chu sequence is shorter than a largest prime number not exceeding the number of the subcarriers after extension and longer than a largest prime number not exceeding the number of the allocation subcarriers.

4. The terminal apparatus according to claim 3,
wherein information related to a sequence length of the Zadoff-Chu sequence is notified from the base station apparatus using the control information.

5. A base station apparatus configured to perform communication with a terminal apparatus, the base station apparatus comprising:
a control unit configured to generate control information at least including information related to the number of allocation subcarriers and bandwidth extension; and
a radio reception unit configured to receive an uplink reference signal obtained by cyclically extending a Zadoff-Chu sequence generated based on the number of subcarriers after extension calculated based on the information related to the number of the allocation subcarriers and the bandwidth extension in such a manner that the uplink reference signal has a sequence length whose number is equal to the number of the subcarriers after extension, the uplink reference signal being transmitted by the terminal apparatus.

6. The base station apparatus according to claim 5,
wherein a sequence length of the Zadoff-Chu sequence is generated using a largest prime number not exceeding the number of the subcarriers after extension.

7. The base station apparatus according to claim 5,
wherein a sequence length of the Zadoff-Chu sequence is shorter than a largest prime number not exceeding the number of the subcarriers after extension and longer than a largest prime number not exceeding the number of the allocation subcarriers.

8. The base station apparatus according to claim 7,
wherein information related to a sequence length of the Zadoff-Chu sequence is included in the control information.

9. The terminal apparatus according to claim 1,
wherein the uplink reference signal includes a first uplink reference signal and a second uplink reference signal, and
wherein a signal sequence length configured for the second uplink reference signal is longer than a signal sequence length configured for the first uplink reference signal.

10. The terminal apparatus according to claim 9,
wherein a first control signal field and a second control signal field are further transmitted, and
wherein a bandwidth of a frequency spectrum of the second control signal field is larger than a bandwidth of a frequency spectrum of the first control signal field.
